(19) United States
(12) Patent Application Publication
(10) Pub. No.: US 2005/0048303 A1
(43) Pub. Date: Mar. 3, 2005

(54) Multilayer films, adhesive constructions, and articles using the same

(76) Inventors: Kevin O. Henderson, Willoughby Hills, OH (US); Michael David Hilston, Painesville, OH (US); Christopher J. Blackwell, Willoughby Hills, OH (US)

Correspondence Address: Heidi A. Boehlefeld;Renner, Otto, Boisselle & Sklar, LLP, Nineteenth Floor, 1621 Euclid Avenue, Cleveland, OH, 44115-2191, US

(21) Appl. No.: 10/927,292

(22) Filed: Aug. 26, 2004

Related U.S. Application Data
(60) Provisional application No. 60/498,879, filed on Aug. 29, 2003.

(51) Int. Cl. B65D 1/00; B32B 1/08; B32B 3/06; B32B 27/08; B32B 27/30

(52) U.S. Cl. 428/516; 428/100; 428/522; 428/36.3

(57) ABSTRACT

This invention relates to a multilayer film comprising (a) a base layer having a first and second surface, wherein the base layer is comprised of at least one polyolefin, and (b) a skin layer on the first surface of the base layer, wherein the skin layer comprises at least about 70% by weight propylene homopolymer, and wherein the multilayer film has a deadfold value from about 45,000 to about 110,000 psi in the machine direction.

This application claims the priority to provisional application Ser. No. 60/498,879 filed on Aug. 29, 2003, the content of which is hereby incorporated by reference in its entirety.

### TECHNICAL FIELD

This invention relates to multilayer films and adhesive constructions such as tapes and tabs for garments, such as diapers, geriatric briefs and the like. This invention also relates to articles using the multilayer film and/or adhesive constructions.

### BACKGROUND

Often an adhesive construction is used on garments, such as disposable diapers, geriatric briefs, and surgical drapes to provide an attachment place for adhesives or closures. Examples of these constructions include tapes and tabs. Previous diaper tape products have problems with premature stretching prior to fastening of the diaper. When the film stretches too easily, the diaper closure may not fasten snuggly to the wearer. U.S. Pat. No. 5,057,097 describes a multilayer film to be used as a diaper tape made by a conventional and simple manner, e.g., coextruding or laminating layers characterized in that one or more layers are non-elastic and another layer is elastic, in which the film becomes substantially completely elastic by stretching beyond the yield strength of the non-elastic layer. U.S. Pat. No. 5,700,571 describes a coextruded film having either two or three layers. The film is described as self-supporting or self wound with a release agent on a second olefin-based polymer support film. Although solutions to premature stretching have been proposed, these solutions do not solve the problem of loss of adhesive properties.

Production lines that use these adhesive constructions are run at high speeds. The production lines use high-speed knives to cut the constructions to the proper length for fitting on the substrate, such as a diaper. One of the problems associated with these adhesive constructions is shattering of the film of the construction during cutting operations with high-speed knives. Films that are very crystalline in construction will tend to shatter more so than less crystalline films, or films with more amorphous domains. The shattering of the film during processing leads to production stoppage or downtime due to cleanup and restarting of the equipment. Films that did not shatter during this step would lead to more efficiency and continued operation or uptime and would be desirable.

One property that the adhesive construction must have is deadfold ability. Deadfold ability is the ability to fold over an edge and not release or lift up from a substrate. When applied, the adhesive construction is often folded over the edge of the substrate. At high speeds, any lack of deadfold ability can cause production delay or ripping of the garment.

Another problem with some polymeric film/adhesive constructions is migration of components of the polymeric film into the adhesive with resultant loss of adhesive properties. The adhesive also contains components that may conversely migrate into the film. Polymeric films often contain additives that may migrate into the adhesive layer and reduce adhesive properties. Additionally, some polymers also have low molecular weight tails, which migrate into the adhesive and reduce the adhesive's properties. Also, low molecular weight material in the adhesive can migrate into the film and cause the adhesive to lose properties. One property that may be reduced is the 180° peel adhesion, as measured by ASTM D1000-61.

A need exists for a multilayer film, which has good deadfold properties, is not too crystalline as to shatter during cutting operations, and minimizes or eliminates reductions in the adhesive properties of the adhesive layer of the construction.

### SUMMARY

This invention relates to a multilayer film comprising (a) a base layer having a first and second surface, wherein the base layer is comprised of at least one polyolefin, and (b) a skin layer on the first surface of the base layer, wherein the skin layer comprises at least about 70% by weight propylene homopolymer, and wherein the multilayer film has deadfold in a modulus range from about 45,000 to about 110,000 psi in the machine direction. In one embodiment, the films have at least one roughened surface. In one embodiment, the films have an adhesive layer on skin layer (b). In one embodiment, the adhesive constructions may be used in a tape or tab, such as a diaper tape or tab. The films of the present invention have improved deadfold properties. The films have reduced impact on the properties of adhesives used in conjunction with the films.

In another embodiment, the invention relates to a multilayer film, comprising (a) a base layer having a first and second surface and comprising at least one polyolefin and at least one tear resistance improving amount of (i) at least one copolymer of ethylene or propylene and at least one unsaturated carboxylic acid or ester, (ii) at least one ionomer of a copolymer of ethylene and at least one unsaturated carboxylic acid, or (iii) mixtures of two or more thereof, (b) a propylene homopolymer skin on the first surface of the base layer, and (c) a polyolefin skin on the second surface of the base layer, wherein the multilayer film has a deadfold in a modulus range from about 45,000 to about 110,000 psi. in the machine direction.

In another embodiment, the invention relates to an adhesive construction comprising a multilayer film having a polyolefin base layer with a first and second surface, (b) a skin layer on the first surface of the base layer, and (d) an adhesive layer on skin layer (b), wherein the skin layer (b) comprises at least greater than 80% by weight propylene homopolymer and wherein the multilayer film has a deadfold in a modulus range from about 45,000 to about 110,000 psi. in the machine direction.

In another embodiment, the invention relates to an adhesive construction comprising (a) a multilayer film having a polyolefin base layer with a first and second surface, (b) a skin layer on the first surface of the base layer, (c) a skin layer on the second surface of the base layer, and (d) an adhesive on skin layer (b) wherein the skin layer (b) comprises at least greater than 80% by weight propylene homopolymer and wherein the multilayer film has a deadfold in a modulus range from about 45,000 to about 110,000 psi. in the machine direction.

In another embodiment, the invention relates to a multilayer film comprising (a) a base layer having a first and second surface, wherein the base layer is comprised of at least one polyolefin, and (b) a skin layer on the first surface of the base layer, wherein the skin layer comprises at least about 70% by weight a polymer selected from a propylene homopolymer, a polyamide, a polyester, a polystyrene, a polycarbonate, and mixtures of two or more thereof, and wherein the multilayer film has a deadfold in a modulus range from about 45,000 to about 110,000 psi. in the machine direction.

### BRIEF DESCRIPTION OF THE DRAWINGS

FIG. 1 is a cross sectional view of a two layer multilayer film.

FIG. 2 is a cross sectional view of a three layer multilayer film.

FIG. 3 is a cross sectional view of an adhesive construction formed from a two-layer multilayer film and an adhesive.

FIG. 4 is a cross sectional view of an adhesive construction formed from a three layer multilayer film and an adhesive.

FIG. 5 is a diaper or garment having an adhesive tape and adhesive tabs applied thereto.

FIG. 6A is a cross sectional view of an adhesive tab before use of the tab to close the garment.

FIG. 6B is a cross sectional view of the adhesive tab once opened and used to close a garment.

FIG. 7A is a cross sectional view of an adhesive tab prior to opening the tab to close the garment.

FIG. 7B is a cross sectional view of an adhesive tab that has been opened and used to close a garment.

FIG. 8A is a cross sectional view of a hook and loop fastener tab prior to opening the tab to close the garment.

FIG. 8B is a cross sectional view of a hook or loop fastener tab that has been opened and used to close a garment.

FIG. 9 is a cross sectional view of an adhesive construction having a hook or loop fastener laminated thereto.

### DETAILED DESCRIPTION

As described above, the present invention relates to a multilayer film that has a base layer having a first and second surface and at least one skin layer on the first surface of the base layer. The multilayer films are characterized as having a deadfold in a modulus range from about 45,000 to about 110,000 psi. in the machine direction. As used herein and throughout the specification and claims, a deadfold value is the measure of the ability of the film to be folded around a material and not lift up from the material. The modulus of the film can be measured according to ASTM D882. In one embodiment, the deadfold is from about 50,000 to about 100,000, or from about 55,000 to about 90,000 psi. in the machine direction.

Here and elsewhere in the specification and claims the range and ratio limits may be combined. Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, or time is, for example, from 1 to 90, or from 20 to 80, or from 30 to 70, it is intended that values such as 15 to 85, 22 to 68, 43 to 51, 30 to 32 etc. are expressly enumerated in this specification. For values which are less than one, one unit is considered to be 0.000 1.0.00 1, 0.0 I or 0. I as 1 5 appropriate. These are only examples of what is specifically intended and all possible combinations of numerical values between the lowest value and the highest value enumerated are to be considered to be expressly stated in this application in a similar manner.

In another embodiment, the multilayer films have improved tear resistance so that the films do not tear during normal handling or application. The Elmendorf Tear is also a means for measuring the amount of crystallization within the structure. A low Elmendorf Tear would correlate to a high amount of crystallization, and thus, a high amount of shattering during the high-speed cutting operation. In one embodiment, the multilayer film has a tear resistance from about 100 to about 1800, or from about 110 to about 1600, or from about 120 to about 1200 grams. Tear resistance has also been referred to as Elmendorf Tear resistance. The tear resistance is measured by ASTM D1922-03.

In one embodiment, the multilayer films have at least one roughened surface. The roughened surface may have a matte finish. In one embodiment, both sides of the multilayer films have a roughened surface. The roughened surfaces improve handling of the film during processing, including adhesive coating. In one embodiment, the multilayer film has a surface roughness from about 25 to about 300, or from about 30 to about 250, or from about 35 to about 200, or from about 40 to about 80 Ra. One convenient measure of surface roughness is provided by the “Ra” roughness average or value measured in angstroms with a Dektak 3030 profile measuring system using a 2.5 um radius stylus. (The Dektak 3030 profile measuring system is manufactured by the Sloan Technology subsidiary of Veeco Instruments Inc. of Santa Barbara, Calif.) The Ra roughness average or value of a surface is defined as the distance between the average peak or projection height and an imaginary median line on the sample surface positioned so that the areas enclosed by the peak portions above the line will be equal to the areas enclosed by the valleys between the peak portions below the line. Hereinafter, such Ra roughness averages or values are reported to indicate the relative roughnesses of surface morphologies.

In one embodiment, the films generally have a thickness from about 1 mil to about 10 mils, or from about 2 mils to about 8 mils, or from about 3 mils to about 6 mils. In one embodiment, the skin layer has thickness sufficient to form a covering over about 80%, or about 90% of the base layer. In one embodiment, the skin layer has sufficient thickness to form a continuous covering over the base layer. In one embodiment, the skin layer comprises from about 1% to about 50%, or from 5% to about 50%, or from about 10% to about 45%, or from about 15% to about 40% of the thickness of the multilayer film. In one embodiment, the multilayer film is a two layer film wherein the skin layer comprises from about 1% to about 50%, or from about 5% to about 50%, from about 15% to about 45%, or from about 20% to about 35% of the thickness of the multilayer film. In another embodiment, the multilayer film is a three layer multilayer film having base layer and two skin layers. In one embodiment, the two skin layers together comprise from about 1% to about 50%, or from about 5% to 50%, or from about 10% to about 45%, or from about 20% to about 35% of the thickness of the multilayer film. In one embodiment, the skin layer or layers independently have a thickness from about 0.5 to about 3, or from about 0.6 to about 2, or from about 0.8 to about 1.5 mil. In another embodiment, the base layer has a thickness from about 0.75 to about 9.5, or from about 1 to about 6, or from about 2 to about 5 mils.

Base Layer

As described above, the multilayer film has a base layer that comprises at least one polyolefin. In one embodiment, the polyolefin comprises at least one propylene homopolymer, at least one propylene copolymer, at least one high density polyethylene or mixtures of two or more thereof. The propylene homopolymers include a variety of propylene homopolymers such as those having melt flow rates (MFR) from about 1 to about 30, or from about 4 to about 25, or from about 8 to about 20 as determined by ASTM Test D1238, condition L. Useful propylene homopolymers also may be characterized as having densities in the range of about 0.88 to about 0.92 g/cm³.

A number of useful propylene homopolymers are available commercially from a variety of sources. Some of the useful homopolymers are listed and described in the following Table I.

TABLE I
Commercial Propylene Homopolymers

| Commercial | | Melt Flow |
|---|---|---|
| Designation | Company | g/10 min |
| WRD5-1057 | Union Carbide | 12.0 |
| DX5E66 | Union Carbide | 8.8 |
| 5A97 | Union Carbide | 3.9 |
| Z9470 | Atofina | 5.0 |
| Z9470HB | Atofina | 5.0 |
| Z9550 | Atofina | 10.0 |
| 6671XBB | Atofina | 11.0 |
| 3576X | Atofina | 9.0 |
| 3272 | Atofina | 1.8 |
| 3622 | Atofina | 12.0 |
| SF6100 | Montell | 11.0 |
| 5390N | Dow Chemical | 12.0 |
| SE66R | Dow Chemical | 8.8 |
| 5A97 | Dow Chemical | 4.0 |
| Moplen HP400N | BaseIl | 12.0 |
| P4G4K 038* | Huntsman | 12.0 |
| P4G4Z-011A | Huntsman | 12.0 |
| 9074*MED | Exxon Mobil | 24.0 |

*contains a nucleating agent

In one embodiment, the base layer comprises at least one propylene copolymer. The propylene copolymers comprise copolymers of propylene and up to about 40% by weight of at least one alpha-olefin selected from ethylene, alpha-olefins containing from 4 to about 12, or from 4 to about 8 carbon atoms, and mixtures thereof. Examples of useful alpha-olefins include ethylene, 1-butene, 1-pentene, 4-methyl-1-pentene, 1-hexene, 1-heptene, and 1-octene. In one embodiment, the copolymers of propylene that are utilized in the present invention comprise copolymers of propylene with ethylene, 1-butene, 1-octene or mixtures thereof. The propylene alpha-olefin copolymers include random as well as block copolymers. Blends of the copolymers as well as blends of the copolymers with propylene homopolymers or high density polyethylene can be utilized as the composition for the base layer. In one embodiment, the propylene copolymers are propylene-ethylene copolymers with ethylene contents from about 0.2% to about 10%, or from about 2% to about 10%, or from about 3% to about 6% by weight. With regard to the propylene-1-butene copolymers, in one embodiment, 1-butene contents of up to about 15% by weight are useful. In one embodiment, the 1-butene content generally may range from about 3% up to about 15%, or from about 5% to about 15% by weight. In one embodiment, propylene-1-octene copolymers useful in the present invention may contain from about 1% up to about 40% by weight of 1-octene. In one embodiment, the propylene-1-octene copolymers will contain from about 3% up to about 20% by weight of 1-octene.

The propylene copolymers may be prepared by techniques well known to those skilled in the art, and many such copolymers are available commercially. For example, the copolymers useful in the present invention may be obtained by copolymerization of propylene with an alpha-olefin such as ethylene or 1-butene using single-site metallocene catalysts. A list of some useful commercially available propylene copolymers is found in the following Table II. In one embodiment, the propylene copolymers useful in the invention have an MFR from about 1 to about 30, or from about 4 to about 20, or from 6 to about 16 g/10 mins.

TABLE II
Commercial Propylene Copolymers

| Commercial | Source | Melt Flow Rate |
|---|---|---|
| DS4D05 | Union Carbide (14% 1-Butene) | 6.5 |
| DS6D20 | Union Carbide (3.2% Ethylene) | 1.9 |
| DS6D81 | Union Carbide (5.5% Ethylene) | 5 |
| SRD4-127 | Union Carbide (8% 1-Butene) | 8 |
| SRD4-104 | Union Carbide (11% 1-Butene) | 5 |
| SRD4-105 | Union Carbide (14% 1-Butene) | 5 |
| DS6D21 | Dow Chemical | 8 |
| DS6D81 | Dow Chemical | 5 |
| KB4560 | BP Amoco | 10 |
| KB4586 | BP Amoco | 10 |
| KB4986 | BP Amoco | 30 |
| 9433* | BP Amoco | 12 |
| 13T25A | Huntsman | 25 |
| P5M4K-046* | Huntsman | 10 |
| P5M5K-047 | Huntsman | 20 |
| P5M2Z-012 | Huntsman | 2 |

*contains nucleating agent

In another embodiment, the base layer may comprise a high density polyethylene. In one embodiment, polyethylene films having a density above about 0.940 g/cm3 and up to about 0.980 g/cm3. Examples of commercially available high density polyethylenes include HDPE 12450N (12 MFR); HDPE 17450N (17 MFR); HDPE 25455N (25 MFR); HDPE 30460M (30 MFR) available from Dow Chemical Company and HDPE 53140 (14 MFR) and HDPE 5302 (25 MFR) available from Atofina.

Tear Resistance Additive

In one embodiment, the base layer also includes at least one tear resistance additive. The tear resistance additive improves the film's ability to resist tear under normal handling. Under high-speed applications, such as those using high-speed knives, the film is less prone to shattering. Although not wishing to be held to a given theory, in one embodiment, it is believed that the addition of the tear resistance additive lowers the amount of crystallization of the base layer. In one embodiment, the tear resistance additive is present in an amount from about 5% to about 60%, or from about 10% to about 50%, or from about 15% to about 40%, or from about 20% to about 30% by weight of the base layer. In one embodiment, tear resistance additive comprises (i) at least one polymer of ethylene or propylene and at least one unsaturated carboxylic acid or ester; (ii) at least one ionomer of polymers of ethylene or propylene and at least one unsaturated carboxylic acid; or (iii) mixtures of two or more thereof. In another embodiment, the tear resistance additive comprises a polymer of ethylene or propylene and at least one monomer selected from acrylic acid, an acrylic ester, methacrylic acid, a methacrylic ester, vinyl acetate, and mixtures of two or more thereof. In one embodiment, the tear resistance additive comprises an ethylene vinyl acetate copolymer.

In one embodiment, the tear resistance additive comprises at least one polymer derived from ethylene or propylene and at least one functional monomer selected from an alkyl acrylate, acrylic acid, a methacrylate, a methacrylic acid, vinyl acetate and combinations of two or more thereof. The functional monomer(s) component of the copolymer or terpolymer ranges from about 1 to about 15, or from about 1 to about 10 mole percent of the copolymer or terpolymer molecule. The acrylate and methacrylate esters independently have from about 1 to about 12, or from about 2 to about 8, or from about 3 to about 6 carbon atoms in the ester group. In one embodiment, the acrylate and methacrylate esters are independently methyl, ethyl, propyl, butyl, pentyl, hexyl, octyl, nonyl, decyle or dodecyl esters.

Examples of tear resistance additives include: ethylene/vinyl acetate copolymers; ethylene/methyl acrylate copolymers; ethylene/ethylacrylate copolymers; ethylene/butyl acrylate copolymers; ethylene/methacrylic acid copolymers; ethylene/acrylic acid copolymers; ethylene/methacrylic acid copolymers containing sodium or zinc (also referred to as ionomers); acid-, anhydride- or acrylate-modified ethylene/vinyl acetate copolymers; acid- or anhydride-modified ethylene/acrylate copolymers; and mixtures of two or more thereof.

In one embodiment, ethylene/vinyl acetate (or EVA) copolymers have a vinyl acetate content from about 2% to about 40%, or from about 4% to about 30%, or from about 6% to about 25% by weight. Examples of commercially available copolymers and terpolymers that can be used include the ethylene/vinyl acetate copolymers available from DuPont under the tradename Elvax. These include Elvax 3120, which has a vinyl acetate content of 7.5% by weight; Elvax 3124, which has a vinyl acetate content of 9% by weight; Elvax 3150, which has a vinyl acetate content of 15% by weight; Elvax 3174, which has a vinyl acetate content of 18% by weight; Elvax 3177, which has a vinyl acetate content of 20% by weight; Elvax 3190, which has a vinyl acetate content of 25% by weight; Elvax 3175, which has a vinyl acetate content of 28% by weight; Elvax 3180, which has a vinyl acetate content of 28% by weight; Elvax 3182, which has a vinyl acetate content of 28% by weight; Elvax 3185, which has a vinyl acetate content of 33% by weight; and Elvax 3190LG, which has a vinyl acetate content of 25% by weight. Ethylene vinyl acetate polymers are also available from AT Plastics under the tradename ATEVA® EVA copolymers. Examples of these include ATEVA® 1075A, which has a vinyl acetate content of 9% by weight and a melt index of 8; ATEVA® 1525, which has a vinyl acetate content of 15% by weight and a melt index of 8; ATEVA® 1820, which has a vinyl acetate content of 18% by weight and a melt index of 3; and ATEVA® 1821, which has a vinyl acetate content of 18% by weight and a melt index of 8.

In one embodiment, the tear resistance additive is at least one ionomer resin. Ionomer resins are available from DuPont under the tradename Surlyn. These are identified as being derived from sodium, lithium or zinc and copolymers of ethylene and methacrylic acid. Ionomer resins include Surlyn 1601, which is a sodium containing ionomer, Surlyn 1605, which is a sodium containing ionomer, Surlyn 1650, which is a zinc containing ionomer, Surlyn 1652 which is a zinc containing ionomer, Surlyn 1702, which is a zinc containing ionomer, Surlyn 1705-1, which is a zinc containing ionomer, Surlyn 1707, which is a sodium containing ionomer, Surlyn 1802, which is a sodium containing ionomer, Surlyn 1855, which is a zinc containing ionomer, Surlyn 1857, which is a zinc containing ionomer, and Surlyn 1901, which is a sodium containing ionomer.

In one embodiment, the tear resistance additive is an ethylene acid copolymer. In one embodiment, the ethylene acid copolymers are copolymers of ethylene and acrylic acid or methacrylic acid. Ethylene acid copolymers available from DuPont under the tradename Nucrel can also be used. These include Nucrel 0407, which has a methacrylic acid content of 4% by weight and Nucrel 0910, which has a methacrylic acid content of 8.7% by weight. The ethylene/acrylic acid copolymers available from Dow Chemical under the tradename Primacor are also useful. These include Primacor 1430, which has an acrylic acid monomer content of 9.5% by weight.

The ethylene/methyl acrylate copolymers available from Chevron under the tradename EMAC can be used. These include EMAC 2205, which has a methyl acrylate content of 20% by weight, and EMAC 2268, which has a methyl acrylate content of 24% by weight.

Various nucleating agents and pigments can be incorporated into the films of the present invention. The amount of nucleating agent added should be an amount sufficient to provide the desired modification of the crystal structure while not having an adverse effect on the desired properties of the films. It is generally desired to utilize a nucleating agent to modify the crystal structure and provide a large number of considerably smaller crystals or spherulites to improve the transparency (clarity), and stiffness, and the diecuttability of the film. Nucleating agents which have been used heretofore for polymer films include mineral nucleating agents and organic nucleating agents. Examples of mineral nucleating agents include carbon black, silica, kaolin and talc. Among the organic nucleating agents include salts of aliphatic mono-basic or di-basic acids or aryalkyl acids such as sodium succinate, sodium glutarate, sodium caproate, sodium 4-methylvalerate, aluminum phenyl acetate, and sodium cinnamate. Alkali metal and aluminum salts of aromatic and alicyclic carboxylic acids such as aluminum benzoate, sodium or potassium benzoate, sodium betanaphtholate, lithium benzoate and aluminum tertiary-butyl benzoate also are useful organic nucleating agents. Substituted sorbitol derivatives such as bis (benzylidene) and bis (alkylbenzilidine) sorbitols wherein the alkyl groups contain from about 2 to about 18 carbon atoms are useful nucleating agents. In one embodiment, sorbitol derivatives such as 1,3,2,4-dibenzylidene sorbitol, 1,3,2,4-di-para-methylbenzylidene sorbitol, and 1,3,2,4-di-para-methylbenzylidene sorbitol are effective nucleating agents for polypropylenes. Useful nucleating agents are commercially available from a number of sources. Millad 8C-41-10, Millad 3988 and Millad 3905 are sorbitol nucleating agents available from Milliken Chemical Co.

The amount of nucleating agent incorporated into the film formulations of the present invention generally range from about 100 to about 6000 ppm of the film. In another embodiment, the amount of nucleating agent in the range of about 1000 to about 5000 ppm.

The base layer may contain other additives to modify the properties of the base layer and adhesive construction and/or tape. For example, colorants may be included in the layer such as TiO₂, CaCO₃, etc. The presence of small amounts of TiO₂, for example, results in a white film. The base layer may contain inorganic fillers and other organic or inorganic additives to provide desired properties such as appearance properties (opaque or colored films), durability and processing characteristics. Examples of useful materials include metal particles, fibers, flame retardants, antioxidant compounds, heat stabilizers, light stabilizers, ultraviolet light stabilizers, optical brighteners, antiblocking agents, processing aids, acid acceptors, etc.

The following examples in Table III relate to compositions useful as base layers in the multilayer films of the present invention. Unless indicated otherwise, the amounts are in parts by weight.

TABLE III

| | A | B | C | D | E | F | G | H | I | J | K |
|---|---|---|---|---|---|---|---|---|---|---|---|
| EP | 100 | 80 | 70 | — | — | — | — | — | — | 65 | — |
| copolymer¹ | | | | | | | | | | | |
| Propylene | — | — | — | 100 | 80 | 75 | — | — | — | 20 | 70 |
| homo- | | | | | | | | | | | |
| polymer² | | | | | | | | | | | |
| HDPE³ | — | — | — | — | — | — | 100 | 95 | 70 | — | — |
| EVA⁴ | — | 20 | 25 | — | — | — | — | — | 25 | 10 | — |
| EAA³ | — | — | — | — | 20 | 25 | — | — | — | — | 5 |
| lonomer⁶ | — | — | — | — | — | — | — | 5 | — | — | 20 |
| Ampacet | — | — | 5 | — | — | 5 | — | — | 5 | 5 | 5 |
| 7182143 ® | | | | | | | | | | | |

¹Dow DS6D81 (5 MFR ethylene propylene copolymer)
²Huntsman P4G4Z-011A (12 MFR)
³Dow HDPE 10262 (10 Melt Index high density polyethylene)
⁴At Plastics 1821 (8 Melt index ethylene-vinyl acetate polymer (18% vinyl acetate))
⁵Nucrel 0910 (ethylene methacrylic acid copolymer containing 8.7% methacrylic acid)
⁶Surlyn 1707 (a sodium containing ionomer, with a melting point of 92° C.)
⁷TiO₂ in ethylene methacrylate carrier, TiO₂ is present at a 70% loading by weight.

Skin Layer

As described herein, the base layer (a) has at least one skin layer (b) on its first surface. In one embodiment, the base layer has skin layer (b) on its first surface and skin layer (c) on its second surface. The skin layers (b) and (c) may have the same or different compositions. It should be noted that the skin layers may be directly adhered to the base layer or may be adhered through an intermediate tie layer. In one embodiment, the skin layer (b) comprises at least 70% by weight propylene homopolymer. The propylene homopolymers include those described above. In one embodiment, the propylene homopolymer of the skin layer has a melt flow rate from about 4 to about 30, or from about 6 to about 25, or from about 8 to about 16 g/10 min. In another embodiment, the propylene homopolymer comprises greater than about 80%, or greater than 85%, or greater than about 90%, or greater than 95% by weight of the skin layer. In one embodiment, the skin layer is comprised completely of propylene homopolymer, provided that any polymers used as carriers for additives to the skin layer may be present in the skin layer. In one embodiment, the amount of these polymers is less than about 2%, or less than about 1%, or less than 0.5% by weight.

In one embodiment, skin layer (b) comprises greater than about 70% by weight of a polymer selected from a propylene homopolymer, a polyamide, a polyester, a polystyrene, a polycarbonate, and mixtures of two or more thereof. The propylene homopolymers have been described above.

Polyamides are also known to those in the art as Nylon polymers. Examples of useful polyamide resins include resins available from EMS American Grilon Inc., Sumter, S.C., under the general tradenames GRIVORY® and GRILON®, such as CF6S, CR-9, XE3303 and G-21. GRIVORY® G-21 is an amorphous nylon copolymer having a glass transition temperature of 125° C., a melt flow index (DIN 53735) of 90 ml/10 min and an elongation at break (ASTM D638) of 15. GRIVORY® CF65 is a nylon 6/12 film grade resin having a melting point of 135° C., a melt flow index of 50 ml/10 min, and an elongation at break in excess of 350%. GRILON® CR9 is another nylon 6/12 film grade resin having a melting point of 200° C., a melt flow index of 200 ml/10 min, and an elongation at break at 250%. GRILON® XE 3303 is a nylon 6.6/6.10 film grade resin having a melting point of 200° C., a melt flow index of 60 ml/10 min, and an elongation at break of 100%. Other useful polyamide resins include those commercially available from, for example, Arizona Chemical Co., Panama City, Fla. under the UNI-REZ® product line, and dimer-based polyamide resins available from Bostik, Emery, Fuller, Henkel (under the VERSAMID® product line). Other suitable polyamides include those produced by condensing dimerized vegetable acids with hexamethylene diamine. Examples of polyamides available from Arizona Chemical include UNI-REZ® 2665; UNI-REZ® 2620; UNI-REZ® 2623; and UNI-REZ® 2695.

In another embodiment, skin layer (B) comprises a polyester. Polyesters include those prepared from various glycols or polyols and one or more aliphatic or aromatic carboxylic acids. Polyethylene terephthalate (PET) and PETG (PET modified with cyclohexanedimethanol) are useful and available from a variety of commercial sources including Eastman Chemical. For example, Kodar 6763 is a PETG available from Eastman Chemical. Another useful polyester from duPont is Selar PT-8307 which is polyethylene terephthalate.

In one embodiment, skin layer (B) comprises a polystyrene. Polystyrenes include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillip Petroleum Co. KR-10 is believed to be a copolymer of styrene with 1,3-butadiene. Another useful polystyrene is a copolymer of styrene and an alkyl acrylate in which the alkyl moiety has 1 to 6 carbon atoms. Butyl acrylate is especially useful as the comonomer of styrene. Styrene/butyl acrylate copolymer dispersions are available under the Trade-mark ACRONAL S312D, S320D and S305D from BASF.

In one embodiment, the polystyrene is a styrene-acryl copolymer. In one embodiment, the acryl may be an acrylic acid or ester, an acrylonitrile or their methacrylic analogs. Examples of the these resins include Microgel E-1002, E-2002, E-5002 (styrene acryl resin emulsion, available from Nippon Paint Co., Ltd.), Voncoat 4001 (acryl emulsion, available from Dainippon Ink & Chemicals, Inc.), Voncoat 5454 (styrene acryl resin emulsion, available from Dainippon Ink & Chemicals, Inc.), SAE 1014 (styrene acryl resin emulsion, available from Nippon Zeon Co., Ltd.), Saivinol SK-200 (acryl resin emulsion, available from Saiden Chemical Industry Co., Ltd.), Nanocryl SBCX-2821 (silicone-modified acryl resin emulsion, available from Toyo Ink Mfg. Co., Ltd.), Nanocryl SBCX-3689 (silicone-modified acryl resin emulsion, available from Toyo Ink Mfg. Co., Ltd.), #3070 (methacrylic acid methyl polymer resin emulsion, available from Mikuni Color Limited), SG-60 (styrene-acryl resin emulsion, available from Gifu Ceramic Co., Ltd.), and Grandol PP-1000 (Styrene-acryl resin emulsion, available from Dainippon Ink & Chemicals, Inc.).

In another embodiment, the skin layer (B) comprises a polycarbonate. Polycarbonates are available from the Dow Chemical Co. (CALIBRE®) G.E. Plastics (LEXAN®) and Bayer (MAKROLON®). Most commercial polycarbonates are obtained by the reaction of bisphenol A and carbonyl chloride in an interfacial process. Molecular weights of the typical commercial polycarbonates vary from about 22,000 to about 35,000, and the melt flow rates generally are in the range from 4 to 22 g/10 min.

In one embodiment, the skin layer (B) is adhered to the base layer (A) through a tie layer. The tie layer may also be used with skin layer (C). Examples of suitable tie layers include Platamid, available from Elf Atochem, and CXA, Bynel, or Plexar series of tie layers available from DuPont Chemical. Another example of a suitable tie coat material is a maleic anhydride functionallzed triblock copolymer consisting of polystyrene end segments and poly(ethylene/butylene) mid-segments sold under the designation KRATON FG1901X by the Shell Chemical Company. In another embodiment, the tear resistance additives, described above, may be used as the tie layer.

In one embodiment, the skin layer includes less than 30%, or less than 20%, or less than 10% by weight of at least one other polyolefin. The polyolefin may be a polyethylene such as a high density polyethylene, low density polyethylene, medium density polyethylene, linear low density polyethylene or the like. In another embodiment, the skin layer may also include an ethylene or propylene copolymers such as those described above. In one embodiment, the skin layer is free of polyethylene imine octadecyl carbamide. In another embodiment, the skin layer is free of long chain fatty carbamide release agents.

In another embodiment, the skin layer may include an antiblocking agent. The addition of antiblocking agents to the film formulations reduces the tendency of the films to block during windup, regulates the slip and anti-static properties of the films and allows a smooth unwinding from the reels. Any of the antiblocking agents described in the prior art as useful additives modifying the properties of polymer films, and in particular, olefin polymer films, can be included in the film formulations of the present invention. Silicas with average particle sizes of about 2 microns or less can be utilized for this purpose, and only small amounts (for example, 1000 to 5000 ppm) of the fine silica are needed. Several antiblocking agents based on synthetic silica are available from A. Schulman, Inc., Akron, Ohio, under the general trade designation Polybatch®. These materials are antiblocking masterbatches and comprise free flowing pellets comprising propylene homopolymers or copolymers and the synthetic silica. For example, Polybatch ABPP 05 comprises 5% synthetic silica in a propylene homopolymer; ABPP 10 comprises 10% synthetic silica in a propylene homopolymer; and ABPP 05SC comprises 5% synthetic silica and a random propylene copolymer. When the antiblocking agents are to be utilized in the preparation of the multilayer films of the present invention, the antiblocking agent generally is added to the skin layer formulations only. Useful antiblocking agents include Ampacet's Seablock 1 and Seablock 4.

The following examples in Table IV relate to skin layers that contain greater than 70% propylene homopolymer that are useful in the present invention. The amounts are in parts by weight.

TABLE IV

| | 1 | 2 | 3 | 4 | 5 | 6 |
|---|---|---|---|---|---|---|
| Propylene | 98 | 90 | 100 | 88 | 70 | 95 |
| homopolymer¹ | | | | | | |
| Propylene copolymer² | — | 8 | — | 10 | 28 | 4 |
| Antiblocking Agent³ | 2 | 2 | — | 2 | 2 | 1 |

¹Huntsman P4G4Z-O11A(12 MFR)
²Dow DS6D81 (5 MFR)
³A. Schulman ABPP055C (silica antiblock)

In one embodiment, skin layer (c) is a polyolefin, such as those described herein. In another embodiment, skin layer (c) comprises a polymer selected from a propylene homopolymer, a polyamide, a polyester, a polystyrene, a polycarbonate, and mixtures of two or more thereof. In another embodiment, skin layer (c) may be a polymer selected from i) at least one homopolymer of ethylene or propylene, (ii) at least one copolymer of propylene and ethylene, (iii) at least one polymer of ethylene or propylene and an alpha olefin having from about 4 to about 18 carbon atoms, or (iv) mixtures thereof. The propylene homopolymers and copolymers are described above. The ethylene polymers may include those described above for the tear resistance additive. In one embodiment, skin layer (c) has same composition as described for skin layer (b) above.

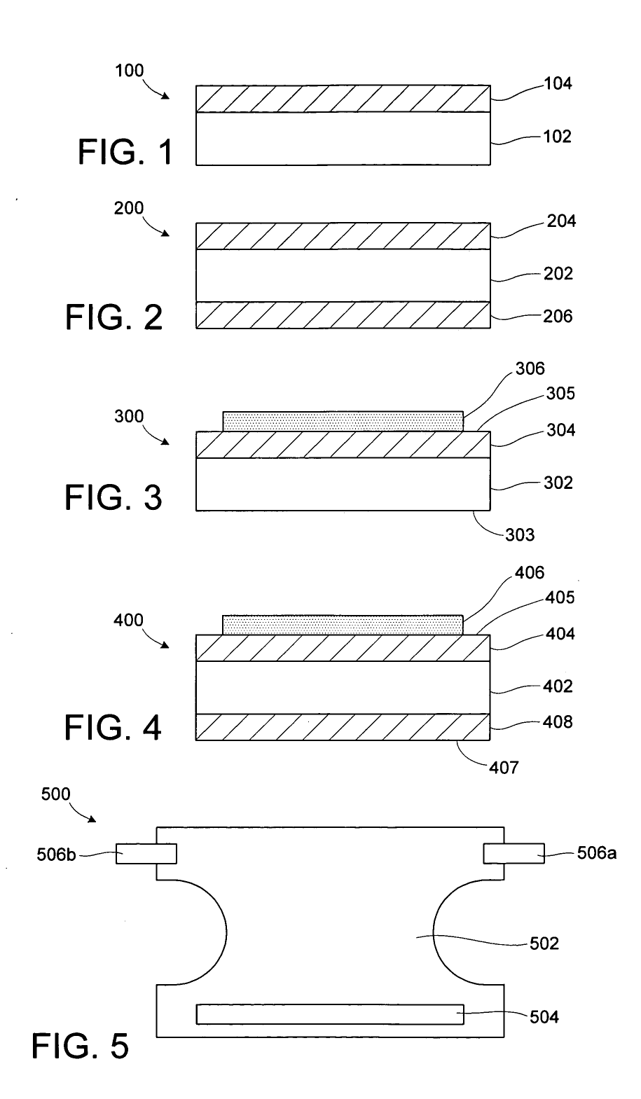

This multilayer film can be made by coextrusion. The film may be prepared by means known to those in the art. Typically the films are extruded at temperatures between 250 to about 550, or about 300 to about 500 degrees F. A useful procedure for preparing the films is extrusion at 450 degrees F. Referring to FIG. 1, film 100 has base layer 102 which is bonded to skin layer 104. Referring now to FIG. 2, three layer multilayer film 200 has base layer 202 which has on its surfaces skin layers 204 and 206.

As described above, in one embodiment, the multilayer film has at least one roughened surface. The roughened surface may be prepared by passing the multilayer film against a metal cooling roll with a surface roughness of 60 Ra using a rubber nip pinning method. The surface roughness from the casting roll is imparted to the surface of the multilayer film. In one embodiment, skin layer (b) has a roughened surface. In another embodiment, skin layers (b) and (c) have a roughened surface.

Useful two layer multilayer films are prepared by coextruding each composition of Examples 1-6 as skin layers with each of the base layers A-K described above. In one embodiment, the films are coextruded and then cast onto a roughened surface metal cooling roll with a surface roughness of 60 Ra using a rubber nip pinning method. The films are a 3.5 mil multilayer two layer films having a skin layer of 1 mil and a base layer of 2.5 mil.

Useful three layer films are prepared by coextruding through a combining adapter feedblock each of the base layer compositions A-K of Table III with skin layers each prepared from Examples 1-6 of Table IV described above. In one embodiment, the films are coextruded and then cast onto a roughened surface metal cooling roll with a surface roughness of 60 Ra using a rubber nip pinning method. The films are a 3.5 mil three layer films having two skin layers of 0.5 mil each and a base layer of 2.5 mil.

Useful three layer films are prepared by coextruding through a combining adapter feedblock each of the base layer compositions A-K with one skin layer prepared from each of Examples 1-6 described above and another skin layer prepared from Union Carbide SRD4-105 propylene copolymer, having 14% 1-Butene and MFR of 5. In one embodiment, the films are coextruded then cast onto a roughened surface metal cooling roll with a surface roughness of 60 Ra using a rubber nip pinning method. The films are a 3.5 mil three layer films having two skin layers of 0.5 mil each and a base layer of 2.5 mil.

Useful three layer multilayer films are prepared by coextruding through a combining adapter feedblock each of the base layer compositions A-K with one skin layer prepared from each of Examples 1-6 described above and another skin layer prepared from Dow Chemical DS6D21, an propylene ethylene copolymer having a MFR of 8. In one embodiment, the films are coextruded and then cast onto a roughened surface metal cooling roll with a surface roughness of 60 Ra using a rubber nip pinning method. The films are a 3.5 mil multilayer three layer films having two skin layers of 0.5 mil each and a base layer of 2.5 mil.

In one embodiment, the multilayer films may be oriented or non-oriented. The films may be stretched and oriented in a single (e.g. uniaxially) or double direction (biaxially). In one embodiment, the film is stretched in the machine direction. After stretching, the film is thermally set or annealed. If the film is not sufficiently annealed, polymer stresses can be locked into the film. The means for orienting the film includes but is not limited to cold stretching, hot stretching, compression rolling, hot compression rolling, and a blown extrusion process. In one embodiment, the film is uniaxially oriented and/or the material is hot stretched.

Adhesives

As described herein, the multilayer films described above may be used together with an adhesive layer to form an adhesive construction. In one embodiment, the adhesive construction is useful as a tape, such as a diaper tape. The diaper tape may be used on the waistband of the diaper as the landing zone for the diaper tab. In another embodiment, the adhesive construction may be used as a diaper tab. The adhesive is generally applied to completely or partially cover the multilayer film construction. It should be understood that the adhesive may also be applied in patterns as well as a continuous layer. The adhesive may be applied directly to the multilayer films above by coating the adhesive onto the skin layer as is known to those in the art.

The adhesive may be a heat-activated adhesive, a hot melt adhesive, or a pressure sensitive adhesive (PSA). Adhesives that are tacky at any temperature up to about 160° C. (about 320° F.) are particularly useful. PSAs that are tacky at ambient temperatures are particularly useful. A variety of conventional PSAs can be utilized.

The adhesives may generally be classified into the following categories:a) random copolymer adhesives such as those based upon acrylate and/or methacrylate copolymers, a-olefin copolymers, silicone copolymers, chloroprene/acrylonitrile copolymers, and the like, b) block copolymer adhesives including those based upon linear block copolymers (i.e., A-B and A-B-A type), branched block copolymers, star block copolymers, grafted or radial block copolymers, and the like, and c) natural and synthetic rubber adhesives. A description of useful pressure-sensitive adhesives may be found in Encyclopedia of Polymer Science and Engineering, Vol. 13. Wiley-Interscience Publishers (New York, 1988). Additional description of useful pressure-sensitive adhesives may be found in Encyclopedia of Polymer Science and Technology, Vol. 1, Interscience Publishers (New York, 1964).

Commercially available pressure-sensitive adhesives are useful in the invention. Examples of these adhesives include the hot melt pressure-sensitive adhesives available from H.B. Fuller Company, St. Paul, Minn. as HM-1597, HL-2207-X, HL-2115X, HL-2193-X. Other useful commercially available pressure-sensitive adhesives include those available from Century Adhesives Corporation, Columbus, Ohio.

In one embodiment, the pressure sensitive adhesive utilized in the present invention comprise rubber based elastomer materials such as linear, branched, graft or radial block copolymers represented by the diblock structures A-B, the triblock A-B-A, the radial or coupled structures (A-B)n, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons which may be monocyclic or bicyclic in nature. The rubbery blocks or segments are polymer blocks of homopolymers or copolymers of aliphatic conjugated dienes. Rubbery materials such as polyisoprene, polybutadiene, and styrene butadiene rubbers may be used to form the rubbery block or segment. Particularly useful rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes which may be utilized include any of those which exhibit elastomeric properties. The block copolymers may be diblock, triblock, multiblock, starblock, polyblock or graftblock copolymers. Throughout this specification and claims, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)0,1,2 . . . BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes which may be utilized to prepare the polymers and copolymers are those containing from 4 to about 10 carbon atoms and more generally, from 4 to 6 carbon atoms. Examples include from 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used. The useful conjugated dienes are isoprene and 1,3-butadiene.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc. The useful vinyl aromatic hydrocarbon is styrene.

Many of the above-described copolymers of conjugated dienes and vinyl aromatic compounds are commercially available. The number average molecular weight of the block copolymers, prior to hydrogenation, is from about 20,000 to about 500,000, or from about 40,000 to about 300,000.

The average molecular weights of the individual blocks within the copolymers may vary within certain limits. In most instances, the vinyl aromatic block will have a number average molecular weight in the order of about 2000 to about 125,000, or between about 4000 and 60,000. The conjugated diene blocks either before or after hydrogenation will have number average molecular weights in the order of about 10,000 to about 450,000, or from about 35,000 to 150,000.

Also, prior to hydrogenation, the vinyl content of the conjugated diene portion generally is from about 10% to about 80%, and the vinyl content is from about 25% to about 65%, or from about 35% to about 55% when it is desired that the modified block copolymer exhibit rubbery elasticity. The vinyl content of the block copolymer can be measured by means of nuclear magnetic resonance.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesives in the present invention include those available from Shell Chemical Company under the tradename Kraton. Specific examples of Kraton Rubbers include D1101 (linear SBS); D1107P (linear SIS); D1111 (linear SIS); D1112P (linear SIS); D1113P (linear SIS); D1117P (linear SIS); and D1320X (multi-arm (SI)n). Vector 4111 is an SIS block copolymer available from Dexco of Houston Tex.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference. Such hydrogenation of the block copolymers which is carried out in a manner and to extent as to produce selectively hydrogenated copolymers having a residual unsaturation content in the polydiene block from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Particularly useful hydrogenated block copolymers are hydrogenated products of the block copolymers of styrene-isoprene-styrene such as a styrene-(ethylene/propylene)-styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed as isoprene, the resulting hydrogenated product resembles a regular copolymer block of ethylene and propylene (EP).

A number of selectively hydrogenated block copolymers are available commercially from Shell Chemical Company under the general trade designation “Kraton G.” One example is Kraton G1652 which is a hydrogenated SBS triblock comprising about 30% by weight of styrene end blocks and a midblock which is a copolymer of ethylene and 1-butene (EB). A lower molecular weight version of G1652 is available from Shell under the designation Kraton G1650. Kraton G1651 is another SEBS block copolymer which contains about 33% by weight of styrene. Kraton G165 is an SEBS diblock copolymer which contains about 13% w styrene. This styrene content is lower than the styrene content in Kraton G1650 and Kraton G1652.

In another embodiment, the selectively hydrogenated block copolymer is of the formula Bn(AB)_{O}Aₚ; wherein n=0 or 1; o is 1 to 100; p is 0 or 1; each B prior to hydrogenation is predominantly a polymerized conjugated diene hydrocarbon block having a number average molecular weight of about 20,000 to about 450,000; each A is predominantly a polymerized vinyl aromatic hydrocarbon block having a number average molecular weight from about 2000 to about 115,000; the blocks of A constituting about 5% to about 95% by weight of the copolymer; and the unsaturation of the block B is less than about 10% of the original unsaturation. In other embodiments, the unsaturation of block B is reduced upon hydrogenation to less than 5% of its original value, and the average unsaturation of the hydrogenated block copolymer is reduced to less than 20% of its original value.

The block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The reaction between the carboxylic acid reagent in the graft block copolymer can be effected in solutions or by a melt process in the presence of a free radical initiator.

The preparation of various selectively hydrogenated block copolymers of conjugated dienes and vinyl aromatic hydrocarbons that have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds are hereby incorporated by reference. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy) hexane by a melt reaction in a twin screw extruder. (See Col. 8, lines 40-61.)

Examples of commercially available maleated selectively hydrogenated copolymers of styrene and butadiene include Kraton FG1901X, FG1921X, and FG1924X from Shell, often referred to as maleated selectively hydrogenated SEBS copolymers. FG1901X contains about 1.7% w bound functionality as succinic anhydride and about 28% w of styrene. FG1921X contains about 1% w of bound functionality as succinic anhydride and 29% w of styrene. FG1924X contains about 13% styrene and about 1% bound functionality as succinic anhydride.

Useful block copolymers also are available from Nippon Zeon Co., 2-1, Marunochi, Chiyoda-ku, Tokyo, Japan. For example, Quintac 3530 is available from Nippon Zeon and is believed to be a linear styrene-isoprene-styrene block copolymer.

The polymer film materials and adhesive compositions used to form the constructions of the present invention may be neat, or they may be emulsions or solvent-based. Emulsion and solvent-based acrylic based PSAs are known and described in, for example, U.S. Pat. Nos. 5,639,811 and 5,164,444, respectively, and these patents are hereby incorporated by reference for such disclosures. When emulsions of the film materials and/or adhesive compositions are used, the water may be removed in an extruder by using the process described and claimed in U.S. Pat. No. 5,716,669 (LaRose et al). The presence of water or solvents during the coextrusion process can result, and generally does result, in pinholes and bubbles in the coextruded film. The presence of voids in the film due to steam is referred to in the art as “moisture slits.”

In one embodiment, the adhesive has a coating weight of less than 40, or less than 20 g/m2. In one embodiment, the adhesive layer has a coat weight in the range from about 0.5 to about 20 g/m2. Alternatively, the thickness of the adhesive layer may range from about 0.02 to about 2, or from about 0.02 to about 0.8 mils. It should be understood that the thickness and coat weight of both the polymer film and the adhesive layer may vary depending upon the different types of polymer film material and adhesives that are selected, and the properties desired in the adhesive construction. For example, different polymers and different film thicknesses will result in constructions having different stiffnesses.

In one embodiment, the adhesive compositions also may contain at least one solid tackifier resin component. A solid tackifier is defined herein as one having a softening point above 80° C. When the solid tackifier resin component is present, the pressure-sensitive adhesive compositions generally comprise from about 40 to about 80% by weight of a thermoplastic elastomer component and from about 20% to about 60%, or from about 55 to 65% by weight of a solid tackifier resin component.

Conventional solid tackifier resins include hydrocarbon resins, rosin, hydrogenated rosin, rosin esters, polyterpene resins, and other resins which exhibit the proper balance of properties. A variety of useful solid tackifier resins are available commercially such as terpene resins which are sold under the trademark Zonatac by Arizona Chemical Company, and petroleum hydrocarbons resins such as the resins sold under the trademark Escorez by Exxon Chemical Company. One particular example of a useful solid tackifier is Escorez 2596 which is a C5-C9 (aromatic modified aliphatic) synthetic tackifier having an Mw of 2100 and a dispersity (Mw/Mn) of 2.69. Another useful solid tackifier is Escorez 1310LC, identified as an aliphatic hydrocarbon resin having an Mw of 1350 and a dispersity of 1.8. Wingtack 95 is a synthetic tackifier resin available from Goodyear, Akron, Ohio consisting predominantly of polymerized structure derived from piperylene and isoprene.

The modulus of the adhesive mixtures also may be lowered by the incorporation of liquid rubbers, i.e., liquid at room temperature. The liquid rubbers generally will have an Mw of at least 5,000 and more often at least 20,000. The incorporation of a liquid rubber also produces an adhesive having increased tack and adhesion. Liquid block copolymers such as liquid styrene-isoprene block copolymers are particularly useful. For example, Kraton LVSI-101, available from the Shell Chemical Company, is effective in lowering the modulus of the adhesive, and it has been found, surprisingly, that this liquid styrene-isoprene block copolymer functions as a processing aid, improving the smoothness of the flow of the adhesive from the die. Kraton LVSI-101 has a weight average molecular weight of about 40,000. Another example of a useful liquid rubber is a liquid polyisoprene obtained by depolymerization of high molecular weight polyisoprene. An example of a commercially available depolymerized high molecular weight polyisoprene is Isolene D-400 from Elementis Performance Polymers, Belleville, N.J., and this liquid rubber has an Mw of about 20,000. Other liquid rubbers which may be incorporated into the adhesive mixture include liquid styrene-butadiene rubbers, liquid butadiene rubbers, ethylene-propylene rubbers, etc.

The adhesive compositions also may include other materials such as antioxidants, heat and light stabilizers, ultraviolet light absorbers, fillers, colorants, antiblocking agents, reinforcing agents, processing acids, etc. Hindered phenolic and amine antioxidant compounds may be included in the adhesive compositions, and a wide variety of such antioxidant compounds are known in the art. A variety of antioxidants are available from Ciba-Geigy under the general trade designations “Irganox” and “Irgafos”. For example, the hindered phenolic antioxidant n-octadecyl 3-(3,5-di-t-butyl-4-hydroxyphenol)-proprionate is available under the general trade designation “Irganox 1076”. Irganox 1010, is identified as Tetrakis (methylene 3-(3N,5N-di-tert-butyl-4N-hydroxyphenol) proprionate) methane. Irgafos 168 is another useful antioxidant from Ciba-Geigy.

Light stabilizers, heat stabilizers, and UV absorbers also may be included in the adhesive compositions. Ultraviolet absorbers include benzo-triazol derivatives, hydroxy benzyl phenones, esters of benzoic acids, oxalic acid, diamides, etc. Light stabilizers include hindered amine light stabilizers, and the heat stabilizers include dithiocarbamate compositions such as zinc dibutyl dithiocarbamate. Hydroquinone-based antioxidants also may be utilized, and one example of such an antioxidant is 2,5-di-tertiary-amyl-hydroquinone.

The adhesive compositions, like the polymeric films, may contain inorganic fillers and other organic and inorganic additives to provide desired properties. Examples of useful fillers include calcium carbonate, titanium dioxide, metal particles, fibers, etc. An example of a useful end-block reinforcing agent is Cumar LX509 from Neville Resins.

Adhesive Constructions

As described above, the multilayer films together with an adhesive layer may form adhesive constructions. In one embodiment, the adhesive constructions are self wound. In this embodiment, the adhesive comes into contact with both sides of the multilayer film. In one embodiment, skin layers (b) and (c) comprise at least about 70% by weight propylene homopolymer. In another embodiment, skin layers (b) and (c) independently comprise at least about 70% by weight of a polymer selected from a propylene homopolymer, a polyamide, a polyester, a polystyrene, a polycarbonate, and mixtures of two or more thereof. One advantage of such three layer multilayer film is that both skin layers of the film have reduced impact on the adhesives properties. The skin layers have little or no low molecular weight tails that migrate into the adhesive layer and affect the adhesive's properties.

The adhesive constructions may be better understood in relationship to the following drawings. Regarding FIG. 3, adhesive construction 300 has base layer 302 with the skin layer 304. The skin layer 304 is bonded to adhesive 306. In one embodiment, the skin layer 304 has a roughened surface 305 as is described above. In another embodiment, the second surface 303 of the base layer 302 has a roughened surface. It should be noted that this construction may also have a release liner on the opposite surface of adhesive film 306. The release liner is not shown. In another embodiment, this adhesive construction may be self wound.

Regarding FIG. 4, adhesive construction 400 has a base layer 402 with skin layers 404 and 408. Skin layer 404 has an adhesive layer 406 bonded to it. In one embodiment, skin layer 404 has a roughened surface 405, as described above. In another embodiment, skin layers 404 and 408 have roughened surfaces, 405 and 407. This adhesive also may have a release liner on the adhesive layer 406. The release liner is not shown. In another embodiment, this adhesive construction may be self wound.

As described above, the adhesive constructions may be used as a tape or tab for disposal diapers, geriatric briefs, surgical drapes or other articles requiring a fastener tab or a tape. As illustrated in FIG. 5, a disposable diaper 500 has the diaper body 502 which is adhered to a diaper tape 504 and diaper tabs 506a and 506b. Diaper tabs 506a and 506b may be any configuration of diaper tab known to those in the art, including the Y configuration and Z configuration of diaper tabs.

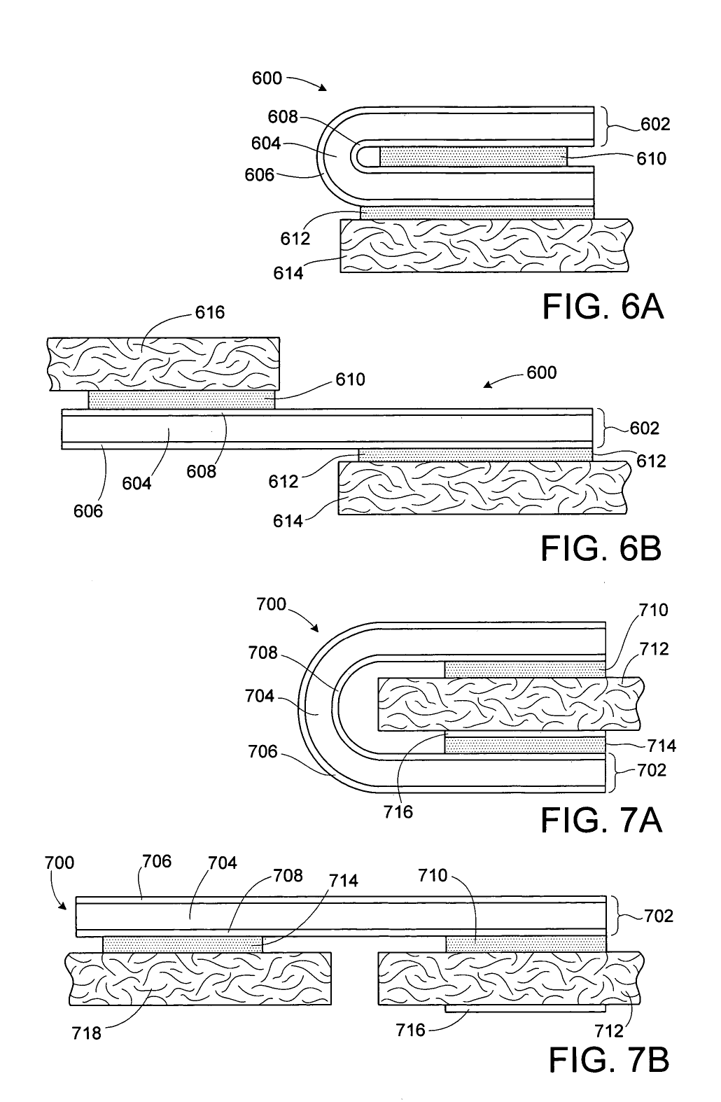

Referring to FIG. 6A, adhesive tab 600 is illustrated having a three layer multilayer film 602 which is composed of a base layer 604 and skin layers 606 and 608 on the surfaces of the base layer. The adhesive tab is folded over on itself and releasably adhered with an adhesive layer 610, such as a pressure sensitive adhesive. The tab is adhered to an adhesive layer 612 which permanently adheres the tab to the diaper extension 614.

FIG. 6B illustrates the application of the tab from FIG. 6A where the diaper tab connects two parts of a diaper. Tab 600 is composed of a three layer film 602 having a base layer 604 with skin layers 606 and 608. The multilayer film 602 is permanently adhered to diaper extension 614 with adhesive 612. Adhesive 610 adheres the multilayer film 602 to diaper surface 616. In one embodiment, the adhesive layer 610 is releasably adhered to the diaper surface 616. Diaper surface 616 may have a release surface such as those formed by an adhesive tape, like those described herein.

FIGS. 7A and B illustrate an adhesive tab which is useful in garments such as diapers. Adhesive tab 700 has a three layer film 702 which is composed of a base layer 704 and two skin layers 706 and 708. The multilayer film 702 is adhered to adhesive layer 710 which permanently adheres to diaper extension 712. Another portion of the multilayer film 702 is releasably adhered to diaper extension 712 through adhesive layer 714 to release layer 716 on diaper extension 712.

FIG. 7B illustrates the application of Tab 700 to provide closure of a diaper. The tab 700 is composed of the multilayer film 702 which has base layer 704 with skin layers 706 and 708. Multilayer film 702 is adhered to diaper extension 712 by way of adhesive layer 710. Diaper extension 712 still has a release layer 716 on one of its surfaces. The multilayer film 702 is also adhered through adhesive 714 to a surface of a portion of the diaper 718.

In another embodiment, the multilayer films and adhesive constructions may be used with hook and loop fasteners which are known to those in the art. Hook and loop fasteners have been described in U.S. Pat. No. 6,524,294, issued in the name of Hilston et al and U.S. Pat. No. 6,419,667 issued in the name of Avalon et al. These patents are hereby incorporated by reference for their disclosure of hook and loop fasteners. The adhesive constructions may contain either the hook or loop portion of the fastener by way of lamination of a substrate containing hook or loop onto the adhesive construction, for instance on a skin layer. The hook and loop fasteners may be used with both the diaper tape or the diaper tab. It is understood that typically the hook or loop would be on the diaper tab or diaper tape.

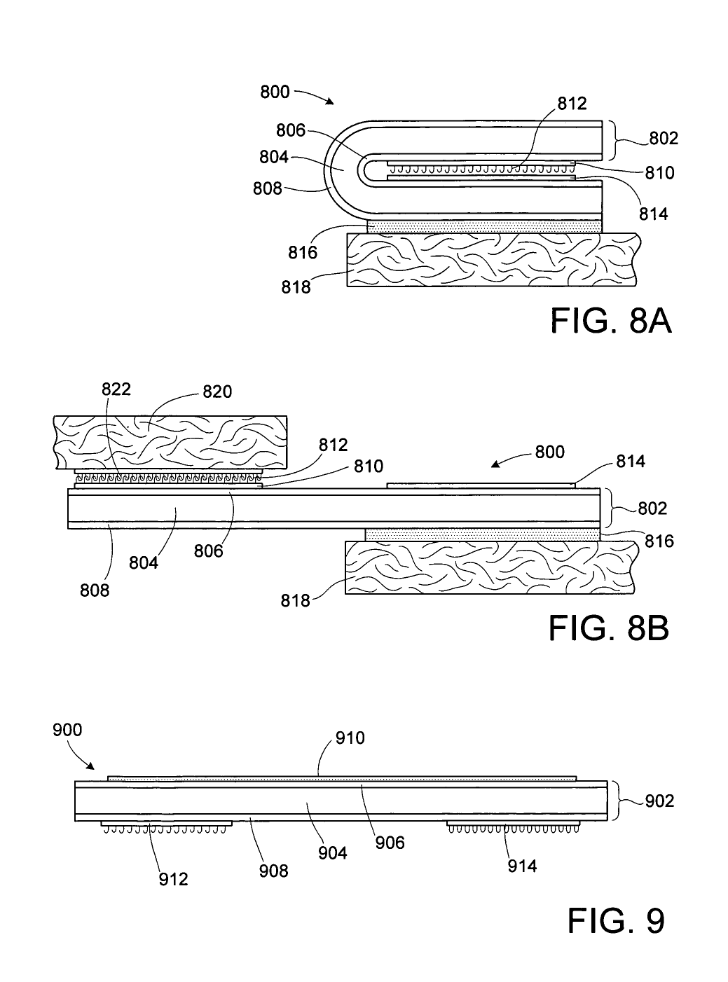

Referring to FIG. 8A, a diaper tab with hooks is illustrated. Diaper tab 800 has multilayer film 802 having base layer 804 and skin layers 806 and 808. Skin layer 806 is laminated to a substrate 810 which has hooks 812 projecting therefrom. The hooks are releasably adhered to coating 814. Skin layer 808 is adhered to diaper extension 818 through adhesive layer 816.

FIG. 8B illustrates the use of the diaper tab as a closure where tab 800 has been opened and adhered to another portion of the garment which has loops to fasten to the hooks. Multilayer film 802 has base layer 804 with skin layers 806 and 808. Skin layer 806 is laminated to a substrate 810 having hooks 812 protruding therefrom. Hooks 812 attach to loops 822 on a portion of diaper 820. Skin layer 806 still has release coating 814 on its surface. Skin layer 808 is adhered to diaper extension 818 through adhesive 816. It is understood that in the diaper tab, the hook and the loop positions may be interchanged. Additionally, it's understood that only one variety of diaper tab has been illustrated but that the other diaper tabs, including those illustrated in this application, may be used with a hook and loop fastener.

In another embodiment, the hook or loop portion is attached to a diaper tape. Referring to FIG. 9, diaper tape 900 has three layer film 902 having a base layer 904 and skin layers 906 and 908. Skin layer 906 is adhered to adhesive layer 910. In one embodiment, skin layer 908 is laminated to substrate 912 which has hooks protruding therefrom. In another embodiment, skin layer 908 is laminated to substrate 914 which has loops on its exposed surface.

While the invention has been explained in relation to several embodiments, it is to be understood that various modifications thereof will become apparent to those skilled in the art upon reading the specification. Therefore, it is to be understood that the invention disclosed herein is intended to cover such modifications as fall within the scope of the appended claims.

1. A multilayer film comprising (a) a base layer having a first and second surface, wherein the base layer is comprised of at least one polyolefin, and (b) a skin layer on the first surface of the base layer, wherein the skin layer comprises at least about 70% by weight propylene homopolymer, and wherein the multilayer film has a deadfold in a modulus range from about 45,000 to about 110,000 psi. in the machine direction.

2. The film of claim 1 wherein the base layer comprises at least one propylene homopolymer, at least one propylene copolymer, at least one high density polyethylene, or mixtures of two or more thereof.

3. The film of claim 1 wherein the base layer comprises a copolymer of propylene and ethylene.

4. The film of claim 1 wherein the base layer further comprises a tear resistance additive.

5. The film of claim 4 wherein the tear resistance additive comprises (i) at least one copolymer of ethylene or propylene and at least one unsaturated carboxylic acid or ester; (ii) at least one ionomer of a copolymer of ethylene and unsaturated carboxylic acid; or (iii) mixtures thereof.

6. The film of claim 4 wherein the tear resistance additive comprises at least one polymer of ethylene or propylene and at least one monomer selected from acrylic acid, an acrylic ester, methacrylic acid, a methacrylic ester, vinyl acetate or mixtures of two or more thereof.

7. The film of claim 4 wherein the tear resistance additive comprises at least one ethylene vinyl acetate polymer.

8. The film of claim 4 wherein the tear resistance additive is present in an amount from about 5% to about 60% by weight.

9. The film of claim 1 wherein the skin layer (b) is comprised of greater than 95% propylene homopolymer.

10. The film of claim 1 wherein the propylene homopolymer has a melt flow rate from about 4 to about 35 g/10 min.

11. The film of claim 1 wherein the skin layer (b) further comprises at least one antiblocking agent.

12. The film of claim 1 wherein the skin layer (b) comprises from about 1% to about 50% of the thickness of the multilayer film.

13. The film of claim 1 further comprising (c) a skin layer on the second surface of the base layer.

14. The film of claim 13 wherein the skin layer (c) comprises at least one polyolefin.

15. The film of claim 13 wherein the skin layer (c) comprises (i) at least one homopolymer of ethylene or propylene, (ii) at least one copolymer of propylene and ethylene, (iii) at least one polymer of ethylene or propylene and an alpha olefin having from about 4 to about 18 carbon atoms, or (iv) mixtures of two or more thereof.

16. The film of claim 1 wherein the multilayer film has a tear resistance from about 100 to about 1800 grams.

17. The film of claim 1 wherein skin layer (b) has a surface roughness from about 25 to about 300 Ra.

18. The film of claim 13 wherein skin layer (c) has a surface roughness from about 25 to about 300 Ra.

19. A multilayer film, comprising (a) a base layer having a first and second surface and comprising at least one polyolefin and at least one tear resistance improving amount of (i) at least one copolymer of ethylene or propylene and at least one unsaturated carboxylic acid or ester, (ii) at least one ionomer of a copolymer of ethylene and at least one unsaturated carboxylic acid, or (iii) mixtures of two or more thereof, (b) a propylene homopolymer skin on the first surface of the base layer, and (c) a polyolefin skin on the second surface of the base layer, wherein the multilayer film has a deadfold value from about 45,000 to about 110,000 in the machine direction.

20. The film of claim 19 wherein the polyolefin of the base layer comprises at least one propylene homopolymer or copolymer.

21. The film of claim 19 wherein the base layer comprises at least one propylene and ethylene copolymer.

22. The film of claim 19 wherein the multilayer film has a tear resistance from about 100 to about 1800 grams.

23. The film of claim 19 wherein the skin layer (b) is comprised of greater than 95% propylene homopolymer.

24. The film of claim 19 wherein skin layer (b) has a surface roughness from about 25 to about 300 Ra.

25. The film of claim 19 wherein skin layer (c) has a surface roughness from about 25 to about 35 Ra.

26. The film of claim 19 wherein both skin layers (b) and skin layer (c) have a roughened surface.

27. The film of claim 19 wherein skin layer (b) is comprised of greater that 95% propylene homopolymer

28. The film of claim 1 further comprising an adhesive layer on skin layer (b).

29. The film of claim 19 further comprising an adhesive layer on skin layer (b).

30. An adhesive construction comprising a multilayer film having a polyolefin base layer with a first and second surface, (b) a skin layer on the first surface of the base layer, and (d) an adhesive layer on skin layer (b), wherein the skin layer (b) comprises at least greater than 80% by weight propylene homopolymer and wherein the multilayer film has a deadfold value from about 45,000 to about 110,000 psi in the machine direction.

31. The adhesive construction of claim 30 wherein the construction comprises a diaper tape or tab.

32. The adhesive construction of claim 30 wherein the construction is self wound.

33. An adhesive construction comprising (a) a multilayer film having a polyolefin base layer with a first and second surface, (b) a skin layer on the first surface of the base layer, (c) a skin layer on the second surface of the base layer, and (d) an adhesive on skin layer (b) wherein the skin layer (b) comprises at least greater than 80% by weight propylene homopolymer and wherein the multilayer film has a deadfold value from about 45,000 to about 110,000 psi in the machine direction.

34. The adhesive construction of claim 33 wherein the construction comprises a diaper tape or tab.

35. The adhesive construction of claim 33 wherein the construction is self wound.

36. A diaper having at least one tab or tape derived from the film of claim 28.

37. A diaper having at least one tab or tape derived from the film of claim 29.

38. A diaper having at least one tab or tape derived from the adhesive construction of claim 30.

39. A diaper having at least one tab or tape derived from the adhesive construction of claim 33.

40. A hook and loop fastener comprising a substrate with hooks or loops laminated to the film of claim 28.

41. A diaper hook and loop fastener comprising a substrate with hooks or loops laminated to the film of claim 29.

42. A hook and loop fastener comprising a substrate with hooks or loops laminated to the adhesive construction of claim 30.

43. A hook and loop fastener comprising a substrate with hooks or loops laminated to the adhesive construction of claim 33.

44. A diaper having at least one hook or loop fastener derived from the fastener of claim 40.

45. A diaper having at least one hook or loop fastener derived from the fastener of claim 41.

46. A diaper having at least one hook or loop fastener derived from the fastener of claim 42.

47. A diaper having at least one hook or loop fastener derived from the fastener of claim 43.

48. A multilayer film comprising (a) a base layer having a first and second surface, wherein the base layer is comprised of at least one polyolefin, and (b) a skin layer on the first surface of the base layer, wherein the skin layer comprises at least about 70% by weight a polymer selected from a propylene homopolymer, a polyamide, a polyester, a polystyrene, a polycarbonate, and mixtures of two or more thereof, and wherein the multilayer film has a deadfold in a modulus range from about 45,000 to about 110,000 psi. in the machine direction.

49. The film of claim 48 further comprising (c) a skin layer on the second surface of the base layer.

50. The film of claim 48 wherein the skin layer (c) comprises a polymer selected from a propylene homopolymer, a polyamide, a polyester, a polystyrene, a polycarbonate, and mixtures of two or more thereof.

51. The film of claim 48 further comprising an adhesive layer on skin layer (b).

52. The film of claim 49 further comprising an adhesive layer on skin layer (b).
